(19) United States
(12) Patent Application Publication
(10) Pub. No.: US 2020/0401958 A1
(43) Pub. Date: Dec. 24, 2020

(54) Systems and Methods for Improvements to Vehicle Routing Including Back-End Operations

(71) Applicant: Google LLC, Mountain View, CA (US)

(72) Inventors: Vincent Furnon, Mountain View, CA (US); Anne-Claire Haury, Mountain View, CA (US); Rohit Arora, Mountain View, CA (US)

(21) Appl. No.: 16/444,554

(22) Filed: Jun. 18, 2019

(51) Int. Cl. G06Q 10/04; G06F 16/29; G06Q 10/08; G01C 21/34

(52) U.S. Cl. CPC G06Q 10/047; G06F 16/29; G01C 21/3453; G01C 21/343; G06Q 10/08355

(57) ABSTRACT

The present disclosure provides systems and methods for generating routing assignments. One example method includes obtaining delivery data associated with a plurality of objects to be delivered from an object distribution hub to a plurality of delivery destinations, wherein a plurality of loading areas are associated with the object distribution hub; obtaining data indicative of a current location for each of the plurality of objects within the object distribution hub; determining data indicative of a respective amount of time required to transfer each of the plurality of objects from its current location to each of the plurality of loading areas; determining routing assignment data based at least in part on the delivery destinations and the respective amount of time required to transfer each of the plurality of objects to each loading area; and providing the routing assignment data to facilitate loading and delivery of the set of one or more objects.

### FIELD

The present disclosure relates generally to computing systems and methods that improve routing assignments. More particularly, the present disclosure relates to improvements in the generation and optimization of routing assignments for the transportation of objects from a distribution hub.

### BACKGROUND

In general, distribution hubs can be extremely large and moving objects (e.g., pallets of goods to be delivered, etc.) from one location (e.g., storage location) to another (e.g., vehicle loading area, etc.) within the distribution hub can take a significant amount of time. In addition to the size of the hub, the available resources such as forklifts and human resources are limited which also contributes to increased delay. The delays accumulated in operations at a distribution hub can adversely impact the efficiency and throughput for a fleet of vehicles, for example, performing last mile delivery from a distribution hub to respective destinations in geographic regions.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for the generation of vehicle routing assignments for one or more distribution vehicles that operate to deliver objects from a distribution hub to delivery destinations. The method includes obtaining, by one or more computing devices, delivery data associated with a plurality of objects to be delivered from an object distribution hub to a plurality of delivery destinations, wherein a plurality of loading areas are associated with the object distribution hub. The method includes obtaining, by the one or more computing devices, data indicative of a current location for each of the plurality of objects within the object distribution hub. The method includes determining, by the one or more computing devices, data indicative of a respective amount of time required to transfer each of the plurality of objects from its current location within the object distribution hub to each of the plurality of loading areas. The method includes determining, by the one or more computing devices, routing assignment data for a distribution vehicle based at least in part on the delivery destinations and the respective amount of time required to transfer each of the plurality of objects to each loading area, wherein the routing assignment data for the distribution vehicle identifies: a set of one or more objects of the plurality of objects to be delivered by the distribution vehicle; a particular loading area for the set of one or more objects to be loaded into the distribution vehicle; and a route for the distribution vehicle to travel from the particular loading area to the delivery destinations respectively associated with the set of one or more objects. The method includes providing, by the one or more computing devices, the routing assignment data to facilitate loading and delivery of the set of one or more objects.

Another example aspect of the present disclosure is directed to a computing system. The computing system includes one or more processors; and one or more non-transitory computer-readable media that store instructions. The instructions, when executed by the one or more processors, cause the computing system to perform operations. The operations include obtaining delivery data associated with a plurality of objects to be delivered outbound from an object distribution hub, wherein the delivery data includes a delivery destination for each of the plurality of objects and wherein a plurality of loading areas associated with the object distribution hub. The operations include obtaining data indicative of a current location for each of the plurality of objects within the object distribution hub. The operations include determining data indicative of a respective amount of time required to transfer each of the plurality of objects from its current location within the object distribution hub to each of the plurality of loading areas associated with the object distribution hub. The operations include determining routing assignment data for a distribution vehicle associated with each of the plurality of loading areas, wherein the routing assignment data identifies a determination of a set of one or more objects of the plurality of objects to be delivered by the distribution vehicle based on the delivery destination for each of the plurality of objects and the amount of time required to transfer each of the one or more objects in the set of objects to the associated loading area, wherein the routing assignment data further identifies a route for the distribution vehicle to travel from the associated loading area to the delivery destinations respectively associated with the set of one or more objects. The operations include providing the routing assignment data to facilitate loading and delivery of the set of one or more objects.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a block diagram of a routing assignment architecture according to example embodiments of the present disclosure;

FIG. 3 depicts a block diagram of example routing for outbound deliveries and inbound pickups according to example embodiments of the present disclosure;

FIG. 4 depicts a flowchart diagram of an example method of generating transportation routing assignments according to example embodiments of the present disclosure; and

FIG. 5 depicts a flowchart diagram of an example method of generating mixed outbound and inbound routing assignments according to example embodiments of the present disclosure.

Reference numerals that are repeated across plural figures are intended to identify the same features in various implementations.

### DETAILED DESCRIPTION

Overview

Example aspects of the present disclosure are directed to systems and methods for improving the generation of vehicle routing assignments for one or more distribution vehicles that operate to deliver objects from a distribution hub to delivery destinations. In particular, the systems and methods of the present disclosure can provide for improvements in the generation and optimization of routing assignments for the delivery of objects from the distribution hub based in part on back-end operations of the distribution hub, for instance, by finding efficient routes for visiting a specified set of locations with a minimum cost. For example, according to an aspect of the present disclosure, the generation of routing assignments can take into account transportation times associated with a distribution hub layout, such as the amount of time to move objects from a current location within a distribution hub to one of a plurality of possible loading areas of the distribution hub (e.g., based on distance between current location of objects and a loading area, resources available to move the objects to a loading area, etc.). According to other aspects of the present disclosure, the systems and methods can provide for optimizing routing assignments for the distribution vehicle(s) using multiple different cost functions, for example, to minimize a fleet size, minimize a distance travelled, minimize a total time travelled, minimize work time for distribution vehicles, and/or other objectives. According to other aspects of the present disclosure, the systems and methods can provide for optimizing for mixed outbound deliveries and inbound pickups in routing assignments. For example, available space in a distribution vehicle can be monitored (e.g., as part of the optimization process) and used to enable object pickup and delivery to be jointly optimized.

More particularly, aspects of the present disclosure enable the generation of route assignment data for a fleet of distribution vehicles (e.g., trucks, cars, aircraft, etc.) to deliver objects from a distribution hub to respective delivery destinations. For example, the distribution vehicles can perform “last mile” delivery of the objects from the distribution hub to respective delivery destinations (e.g., homes, business, etc.). In particular, in some implementations, a computing system can perform one or more optimization routines using one or more objective cost functions to generate the route assignment data for the distribution vehicles. Thus, the computing system can obtain delivery data that describes object(s) to be delivered, vehicle data that describes available distribution vehicle(s) (and optionally their characteristics such as available space for carrying objects), map data that describes potential travel paths to and from various locations (e.g., roadways and the like), and/or other forms of data and can perform the optimization routine(s) to generate the route assignment data for the distribution vehicle(s). Specifically, in some instances, the route assignment data for each distribution vehicle can describe which object(s) the vehicle should retrieve or accept from the distribution hub, where such object(s) are to be delivered, and a route by which the distribution vehicle should travel from the distribution hub to the delivery destination(s) associated with its object(s). As will be described further below, in some implementations, the route assignment data can further describe which of a number of possible loading areas of the distribution hub should be used to obtain the object(s) from the hub and/or identify certain inbound objects to be retrieved from pickup locations and transported to the distribution hub (e.g., after completion of one or more of the scheduled deliveries).

In particular, according to one aspect of the present disclosure, the systems and methods can provide for taking time delays associated with a distribution hub layout into account when generating routing assignments for delivery of objects stored within the distribution hub. Generally, distribution hubs can be extremely large and moving objects (e.g., pallets of goods to be delivered, etc.) from one location (e.g., storage location) to another (e.g., loading dock, etc.) within the distribution hub can take a significant amount of time. In addition to the size of the distribution hub, the available resources, such as forklifts and human resources, to move objects within the distribution hub may be limited which can also contribute to increased delay. In some implementations, the determination of routing assignments can take into account the amount of time it would take to move each of the objects being delivered to a particular delivery loading area (e.g., loading dock, bay, door, gate, etc.) when determining which objects should be loaded on which vehicles (e.g., associated with a particular loading area) for delivery. For example, the systems and methods of the present disclosure can receive as input data indicative of objects being shipped or otherwise transported including the delivery destinations, where the objects being transported are currently located in the distribution hub (e.g., a current location), resources available to move the objects within the distribution hub, and/or what distribution vehicles and associated loading areas are available for routing of the object deliveries.

The systems and methods can then determine routing assignments for the distribution vehicle(s) indicative of what object(s) should be loaded onto each vehicle based in part on the current location of the objects in the distribution hub as well as the delivery destination(s). For example, in some implementations, for each pair of vehicle/loading area and storage location within the distribution hub, a cost can be defined that is proportional to the distance between the vehicle/loading area and the storage location (e.g., indicative of time required to move objects from the storage location to the vehicle/loading area). This cost can then be used in determining what objects should be loaded on each vehicle as part of the building and/or optimization of routes in the generation of routing assignments (e.g., penalizing shipments according to their distance from the vehicle/loading area, etc.). The accounting for delays based on distribution hub layout may be used in determining how delivery routes are built without influencing the way objects are stored within the distribution hub (e.g., the way objects are placed within the distribution hub when obtained). In some implementations, if multiple objects are to be loaded onto a distribution vehicle at a same stop at the hub, a largest delay (e.g., in departure time, etc.), intra-hub transportation cost, or other metric can be used as representative of the multiple objects.

According to another aspect of the present disclosure, the systems and methods can provide improvements in vehicle routing by optimizing routing assignment generation using chained solves of multiple different cost functions. As examples, the multiple different cost functions can seek to minimize a fleet size, minimize a distance travelled, minimize a total time travelled, minimize total work time for a distribution vehicle, or other objectives. For instance, vehicle routing for a distribution hub can represent large problems where it is difficult to solve for an optimal solution. In some implementations, the systems and methods can provide for solving using multiple cost functions to nudge the optimization in different directions to determine a best solution. For example, routing assignment data can be optimized using a first cost function objective (e.g., minimizing time, etc.). Then, the routing assignment data (e.g., time optimized routing) can be re-optimized using a second cost function objective (e.g., minimizing distance traveled, etc.). The different cost functions can be applied to move the routing assignment data optimization back and forth, while tracking the best solution(s) at each step. In some implementations, the optimization using multiple different cost functions can provide for finding a single best solution. In some implementations, the optimization using multiple different cost functions can provide for finding a ranked list of best solutions. In some implementations, multiple different solutions from different stages along the optimization process can be stored and then presented to a human user for analysis and/or selection.

According to another aspect of the present disclosure, in some implementations, the systems and methods of the present disclosure can jointly optimize distribution vehicle routes for both outbound deliveries and inbound pickups. Thus, the systems and methods can provide for determining routing assignments including a mix of outbound deliveries and inbound pickups in routes. For instance, routes can be generated where all deliveries are executed outbound from the distribution hub first and then inbound pickups are made on a return route to the distribution hub. Alternatively or additionally, routing assignments can provide for mixing one or more inbound pickups among the outbound deliveries along a route. The systems and methods can provide for taking into account certain constraints when determining routing assignments for outbound deliveries and/or inbound pickups, such as time windows for deliveries and pickups, vehicle capacity, pickup object data (e.g., volume, weight, pallet loading constraints, etc.), pickup location, and/or the like.

Additionally, according to aspects of the present disclosure, a vehicle emptiness factor can be used in generating routing assignments for inbound pickups. The vehicle emptiness factor can be indicative of how empty a vehicle is after a delivery stop, thereby providing for a determination if there is space within the vehicle to move objects to allow for loading inbound pickups without hampering further outbound deliveries assigned to the vehicle (e.g., such that unloading and reloading objects along the route is not required). Routing assignments can then be determined whereby a same vehicle can intersperse inbound pickups with outbound deliveries. In some implementations, the vehicle emptiness factor can be defined based on user preferences. For instance, in some implementations, an emptiness factor can be set at a lower value to ensure that a vehicle has significant empty space to accommodate inbound pickups. As one example, an emptiness factor can be set at 0 (e.g., vehicle completely empty) to ensure that all deliveries are made before pickups are initiated (e.g., pure backhaul). In some implementations, such mixed inbound/outbound routing assignments can be optimized to minimize a number of vehicles required to accommodate the outbound deliveries and inbound pickups. In some implementations, such mixed inbound/outbound routing assignments can be optimized to minimize the distance traveled to accommodate the outbound deliveries and inbound pickups. In some implementations, such mixed inbound/outbound routing assignments can be optimized to minimize the travel time needed to accommodate the outbound deliveries and inbound pickups.

Similar to object deliveries, in some implementations, there may be multiple different possible locations at which an object pickup can be performed and the systems and methods of the present disclosure can take this factor into account when performing the routing optimization process. For example, the different pickup locations can be different possible solutions that can be considered during the optimization process.

In some implementations, the routing assignment optimization can include aggregating service times for routes. For example, the optimization can take into account the aggregate work being done at a site for delivery and/or pickup to allow for generating finer estimations of time to load/unload in a routing assignment.

In some implementations, the system can include a data pipeline that provides real-time data which can enable the route optimization process to be performed on an ongoing basis. As one example, each distribution vehicle can include sensors (e.g., GPS, etc.) that determine and report the location of the vehicle in real-time. As another example, each loading area of the distribution hub can include sensors (e.g., cameras or systems that track loading events, etc.) that indicate to what extent there is currently a backlog of vehicles seeking to access the loading area. The system can use this and/or other real-time information to continuously re-optimize the routing assignment data for the fleet of vehicles.

The systems and methods of the present disclosure provide a number of technical effects and benefits. As one example, the systems and methods described herein can provide for optimizing routing assignments to minimize delivery fleet size. For example, by optimizing routing assignments such as by taking into account delays associated with distribution hub layout, optimizing mixed outbound and inbound shipments, aggregating service times, and the like, the systems and methods can provide for improvements in route timing, distance traveled, etc., thereby improving efficiency of each route and as a result reducing the number of vehicles required to effectuate the delivery routes.

With reference now to the Figures, example embodiments of the present disclosure will be discussed in further detail.

### Example Devices and Systems

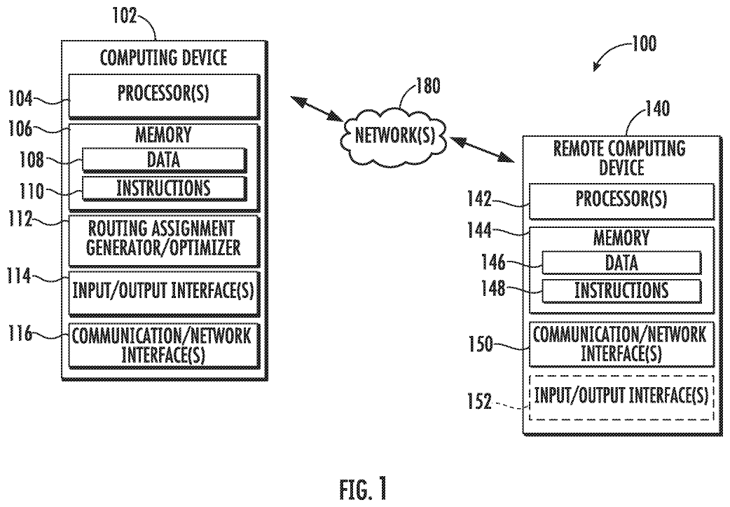

FIG. 1 depicts a block diagram of an example computing system 100 that can facilitate the generation and optimization of routing assignments for the transportation of objects from a distribution hub, according to example embodiments of the present disclosure. FIG. 1 illustrates one example computing system 100 that can be used to implement the present disclosure. Other computing systems that include different components can be used in addition or alternatively to the system 100. The system 100 may comprise one or more computing devices, such as computing device 102 and one or more remote computing devices (e.g., server computing systems, etc.), such as remote computing device 130, that are communicatively coupled over one or more networks, such as network 180.

The computing device 102 can be any type of computing device, such as, for example, a personal computing device (e.g., laptop or desktop), a server computing device, or any other type of computing device. The computing device 102 includes one or more processors 104 and one or more memories 106. The one or more processors 104 can be any suitable processing device (e.g., a processor core, a microprocessor, an ASIC, a FPGA, a controller, a microcontroller, etc.) and can be one processor or a plurality of processors that are operatively connected. The memory 106 can include one or more non-transitory computer-readable storage mediums, such as RAM, ROM, EEPROM, EPROM, flash memory devices, magnetic disks, etc., and combinations thereof. The memory 106 can store data 108 and instructions 110 which are executed by the processor 104 to cause the computing device 102 to perform operations, including one or more of the operations disclosed herein.

According to aspects of the present disclosure, the computing device 102 can include a routing assignment optimizer 112 that can implement features of the present disclosure, such as improvements in the generation and optimization of routing assignments for the transportation of objects from a distribution hub based in part on back-end operations of the distribution hub. For instance, the routing assignment optimizer 112 can take into account transportation times associated with a distribution hub layout, such as the amount of time to move objects from a current location within a distribution hub to one of a plurality of possible loading areas of the distribution hub, as part of the generation and optimization of routing assignments.

For example, the computing device 102 (e.g., routing assignment optimizer 112, etc.) can obtain delivery data associated with a plurality of objects to be transported from a distribution hub to a plurality of destinations and data indicative of a current location for each of the plurality of objects within the distribution hub. The distribution hub can include a plurality of loading areas (e.g., loading docks, bays, doors, etc.) where objects can be loaded onto distribution vehicles for transportation to various destinations. The routing assignment optimizer 112 can determine data indicative of a respective amount of time required to transfer each of the plurality of objects from its current location within the distribution hub to each of the plurality of loading areas. The routing assignment optimizer 112 can provide for generating routing assignment data for one or more distribution vehicles. The routing assignment optimizer 112 can generate routing assignments based at least in part on the delivery destinations of each of a plurality of objects and a respective amount of time required to transfer each of the plurality of objects to each loading area within the distribution hub. The routing assignment data can describe a set of objects (e.g., from the plurality of objects to be delivered) to be transported from the distribution hub by a distribution vehicle, a particular loading area for the objects to be loaded into the distribution vehicle, and a route for the distribution vehicle to travel from the distribution hub to the delivery destinations respectively associated with the objects in the set of objects. In some implementations, the computing device 102 (e.g., routing assignment optimizer 112, etc.) can obtain geographic/map data, such as transportation routes, distances, travel time(s), traffic conditions, and/or the like, for use in the generation and/or optimization of the routing assignment data. The computing device 102 can provide the routing assignment data to facilitate loading and delivery of the objects, for example, to perform “last mile” delivery of the objects from the distribution hub to respective delivery destinations (e.g., homes, business, etc.).

In addition, in some implementations, the routing assignment optimizer 112 can provide for optimizing routing assignments for the distribution vehicle(s) using multiple different cost functions, for example, to minimize a fleet size, minimize a distance travelled, minimize a total time travelled, minimize a work time for distribution vehicles, and/or other objectives. Further, in some implementations, the routing assignment optimizer 112 can provide for generating and/or optimizing routing assignments including a mix of outbound deliveries and inbound pickups for a distribution vehicle (e.g., based on available space in a distribution vehicle after one or more deliveries are completed, etc.).

In some implementations, a computing system can perform one or more optimization routines using one or more objective cost functions to generate the route assignment data for the distribution vehicles. Thus, the computing system can obtain delivery data that describes object(s) to be delivered, vehicle data that describes available distribution vehicle(s) (and optionally their characteristics such as available space for carrying objects), map data that describes potential travel paths to and from various locations (e.g., roadways and the like), and/or other forms of data and can perform the optimization routine(s) to generate the route assignment data for the distribution vehicle(s).

The routing assignment optimizer 112 can include computer logic utilized to provide desired functionality. The routing assignment optimizer 112 can be implemented in hardware, firmware, and/or software controlling a processor, such as processor 104. For example, in some implementations, the routing assignment optimizer includes program files stored on a storage device, loaded into a memory such as memory 106 and executed by one or more processors such as processor 104. In other implementations, the routing assignment optimizer 112 includes one or more sets of computer-executable instructions that are stored in a tangible computer-readable storage medium such as RAM hard disk or optical or magnetic media.

The computing device 102 can also include one or more input/output interface(s) 114. One or more input/output interface(s) 114 can include, for example, devices for receiving information from or providing information to a user, such as through a display device, touch screen, touch pad, mouse, data entry keys, an audio output device such as one or more speakers, a microphone, haptic feedback device, etc. The computing device 102 can also include one or more communication/network interface(s) 116 used to communicate with one or more systems or devices, including systems or devices that are remotely located from the computing device 102.

In some implementations, the computing device 102 can provide route assignment data to the distribution vehicle(s) and/or vehicle operator(s) associated with a distribution vehicle. For example, the computing device 102 can provide route assignment data to a remote computing device (e.g., remote from computing device 102), such as a navigation device and/or the like associated with a distribution vehicle and/or an autonomous distribution vehicle.

The remote computing system 140 can include one or more processors 142 and one or more memories 144. The one or more processors 142 can be any suitable processing device (e.g., a processor core, a microprocessor, an ASIC, a FPGA, a controller, a microcontroller, etc.) and can be one processor or a plurality of processors that are operatively connected. The memory 144 can include one or more non-transitory computer-readable storage mediums, such as RAM, ROM, EEPROM, EPROM, flash memory devices, magnetic disks, etc., and combinations thereof. The memory 144 can store data 146 and instructions 148 which are executed by the processor 142 to cause the remote computing system 140 to perform operations, for example, such as to implement operations as discussed herein. The remote computing system 140 may generate, store, process, and/or the like video data, procedure data, result data, medical device data, models, and/or the like which can be associated with implementation of one or more operations of the present disclosure, for example, by providing such data to the computing device 102.

In some implementations, the remote computing system 140 includes or is otherwise implemented by one or more server computing devices. In instances in which the remote computing system 140 includes plural server computing devices, such server computing devices can operate according to sequential computing architectures, parallel computing architectures, or some combination thereof.

The remote computing system 140 can also include one or more communication/network interface(s) 150 used to communicate with one or more systems or devices, including systems or devices that are remotely located from the remote computing system 140, such as computing device 102, for example. The remote computing system 140 can also include one or more input/output interface(s) 152, for example, devices for receiving information from or providing information to a user.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML, JSON), and/or protection schemes (e.g., VPN, secure HTTP, SSL).

### Example Routing System Arrangements

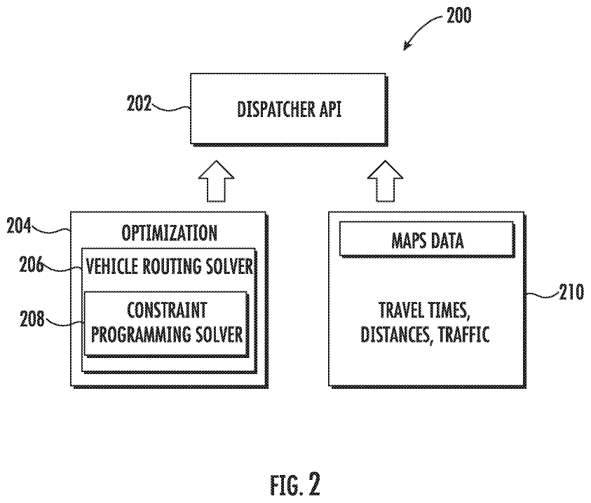

FIG. 2 depicts a block diagram of a routing assignment architecture 200 according to example embodiments of the present disclosure. In some implementations, the routing assignment architecture 200 can provide for improvements in the generation and optimization of routing assignments for the transportation of objects from a distribution hub. As an example, the routing assignment architecture 200 can provide for receiving input data indicative of objects being shipped or otherwise transported including the delivery destinations, where the objects being transported are currently located in the distribution hub (e.g., a current location), and what distribution vehicles and associated loading areas are available for routing of the object deliveries. The routing assignment architecture 200 can provide for generating and/or optimizing routing assignments for the distribution vehicle(s) indicative of what object(s) should be loaded onto each vehicle based in part on the current location of the objects in the distribution hub as well as the delivery destination(s). The routing assignment architecture 200 can provide routing assignment data descriptive of which object(s) a distribution vehicle should retrieve or accept from the distribution hub, where such object(s) are to be delivered, and a route by which the distribution vehicle should travel from the distribution hub to the delivery destination(s) associated with its object(s).

As illustrated in FIG. 2, in some implementations, the routing assignment architecture 200 can include a dispatcher application programming interface (API) 202 and an optimization system 204. In some implementations, the optimization system 204 can be implemented as part of the dispatcher API 202. Additionally, in some implementations, the routing assignment architecture 200 (e.g., dispatcher API 202, etc.) can communicate with one or more other systems (e.g., remote server computing systems, cloud-based services, etc.), for example, to obtain maps data 210 (e.g., routing directions, driving times, driving distances, road traffic conditions, etc.). As one example, in some implementations, the routing assignment architecture 200 can be included as part of and/or associated with a computing device 102 of computing system 100 as described with regard to FIG. 1. For instance, computing device 102 of FIG. 1 can implement and/or be associated with a dispatcher API 202 and an optimization system 204, for example, being implemented in association with routing assignment optimizer 112 of FIG. 1. Additionally or alternatively, in some implementations, the routing assignment architecture 200 (e.g., dispatcher API 202, optimization system 204, etc.) can be implemented as part of a cloud-based service and/or the like.

The dispatcher API 202 can facilitate the generation of vehicle routing solutions, for example, generating routes for a vehicle fleet such as a fleet of distribution vehicles picking up and delivering objects to various destinations, service vehicles making on-site calls, vehicles transporting passengers, and/or the like. For example, in some instances, a dispatcher API 202 can solve vehicle routing problems with hundreds of vehicles and thousands of locations. In particular, as described herein, the dispatcher API 202 can provide for the generation and optimization of routing for one or more distribution vehicles that operate to deliver objects from a distribution hub to delivery destinations.

The optimization system 204 can be associated with and/or implemented as part of the dispatcher API 202 and can facilitate finding efficient routes for visiting a specified set of locations with a minimum cost. As illustrated in FIG. 2, in some implementations, the optimization system 204 can include a vehicle routing solver 206 and a constraint problem solver 208. As described herein, in some implementations, the optimization system 204 (e.g., vehicle routing solver 206) can take into account operational delays including delays associated with a distribution hub layout, such as the amount of time to move objects from a current location (e.g., storage location) within a distribution hub to one of a plurality of possible loading areas of the distribution hub in the generation and optimization of routing assignments.

In some implementations, the vehicle routing solver 206 can generate distribution vehicle routing including a mix of both outbound deliveries and inbound pickups in a route. For instance, routes can be generated where all deliveries are executed outbound from the distribution hub first and then inbound pickups are made on a return route to the distribution hub. Alternatively or additionally, routing assignments can provide for mixing one or more inbound pickups among the outbound deliveries along a route. The optimization system 204 can provide for taking into account certain constraints when determining routing assignments for outbound deliveries and/or inbound pickups, such as time windows for deliveries and pickups, vehicle capacity, pickup object data (e.g., volume, weight, pallet loading constraints, etc.), pickup location, and/or the like. In some implementations, the optimization system 204 (e.g., vehicle routing solver 206) can use a vehicle emptiness factor in generating routing assignments for inbound pickups. The vehicle emptiness factor can be indicative of how empty a vehicle is after a respective delivery stop, thereby providing for a determination if there is space within the vehicle to move objects to allow for loading inbound pickups without hampering further outbound deliveries assigned to the vehicle (e.g., such that unloading and reloading objects along the route is not required).

In some implementations, the optimization system 204 (e.g., constraint problem solver 208) can provide for optimizing routing assignments for distribution vehicles using multiple different cost functions, for example, to minimize a fleet size, minimize a distance travelled, minimize a total time travelled, minimize total work time for a vehicle, and/or other objectives. For example, the constraint problem solver 208 can provide for using chained solves of multiple different cost functions in generating and/or optimizing routing assignments. The multiple different cost functions can seek to minimize a fleet size, minimize a distance travelled, minimize a total time travelled, minimize a work time for distribution vehicles, and/or other objectives. The constraint problem solver 208 can provide for solving using multiple cost functions to nudge the optimization in different directions to determine a best solution. For example, routing assignment data can be optimized using a first cost function objective (e.g., minimizing time, etc.). Then, the routing assignment data (e.g., time optimized routing) can be re-optimized using a second cost function objective (e.g., minimizing distance traveled, etc.). The different cost functions can be applied to move the routing assignment optimization back and forth, while tracking the best solution(s) at each step.

In some implementations, routing assignment optimization can include aggregating service times for routes. For example, the optimization system 204 can take into account the aggregate work being done at each respective site for delivery and/or pickup to allow for generating finer estimations of time to load/unload in a routing assignment.

In some implementations, the dispatcher API 202 can obtain maps data 210 (e.g., from one or more remote services, etc.) including driving directions, driving times, distances, and/or traffic conditions (e.g., predicted and/or live) for use in the generation and/or optimization of the routing assignments.

Each of the dispatcher API 202 and optimization system 204 can include computer logic utilized to provide desired functionality. Each of the dispatcher API 202 and optimization system 204 can be implemented in hardware, firmware, and/or software controlling a processor, such as processor 104 of FIG. 1. For example, in some implementations, each of the dispatcher API 202 and optimization system 204 includes program files stored on a storage device, loaded into a memory such as memory 106 of FIG. 1 and executed by one or more processors such as processor 104 of FIG. 1. In other implementations, each of the dispatcher API 202 and optimization system 204 includes one or more sets of computer-executable instructions that are stored in a tangible computer-readable storage medium such as RAM hard disk or optical or magnetic media.

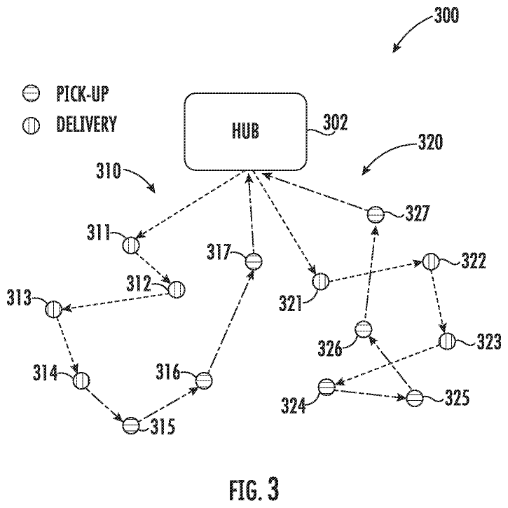

FIG. 3 depicts a block diagram of example routing 300 for outbound deliveries and inbound pickups according to example embodiments of the present disclosure. As illustrated in FIG. 3, routing assignments can be generated (e.g., by computing device 102, routing assignment optimizer 112, routing assignment architecture 200, etc.) to provide for outbound deliveries of objects from a distribution hub, such as hub 302, as well as inbound pickups for objects to be returned to the distribution hub (e.g., hub 302).

As one example, a first routing assignment 310 may include traveling to a first delivery location 311, then to a second delivery location 312, then to a third delivery location 313, and then to a fourth delivery location 314 to make outbound deliveries of objects from the hub 302. Upon completion of the assigned deliveries, the first routing assignment 310 may further include traveling to a first pickup location 315, then to a second pickup location 316, and then to a third pickup location 317 to pickup inbound shipments to be returned to the hub 302.

A second routing assignment 320 may include traveling to a series of delivery location 321, 322, 323, and 324 to outbound deliveries of objects from the hub 302, and upon completion of the deliveries, may further include traveling to pickup locations 325, 326, and 327 to pickup inbound shipments to be returned to the hub 302.

In some implementations, routing assignments can be generated and/or optimized (e.g., by computing device 102, routing assignment optimizer 112, routing assignment architecture 200, etc.) for mixed outbound deliveries and inbound pickups along routes, as an alternative to pure backhaul routing (e.g., all deliveries are completed first, then all pickups are completed on a return route to a hub). For example, in some implementations, a vehicle emptiness factor for a distribution vehicle can be used in generating and/or optimizing routing assignments to include for inbound pickups (e.g., generating routing assignments that provide for mixing one or more inbound pickups interposed among the outbound deliveries along a route). In some implementations, such mixed inbound/outbound routing assignments can be optimized to minimize the distance traveled to accommodate the outbound deliveries and inbound pickups. In some implementations, such mixed inbound/outbound routing assignments can be optimized to minimize the travel time needed to accommodate the outbound deliveries and inbound pickups.

### Example Methods

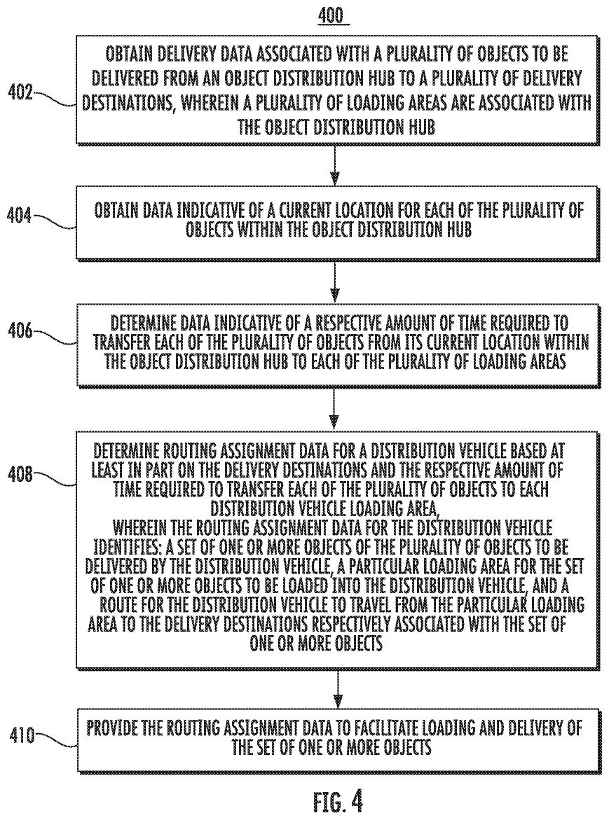

FIG. 4 depicts a flowchart diagram of example method 400 for generating transportation routing assignments according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure. Method 400 can be implemented by one or more computing systems, such as one or more of the computing devices depicted in FIG. 1.

At 402, method 400 can include the computing system (e.g., computing device 102, routing assignment architecture 200, etc.) obtaining delivery data associated with a plurality of objects to be delivered from an object distribution hub to a plurality of delivery destinations, wherein a plurality of loading areas are associated with the object distribution hub. In particular, the delivery data can be associated with “last mile” delivery of the objects from the object distribution hub to respective delivery destinations (e.g., homes, business, etc.) to be performed by a fleet of vehicles associated with the object distribution hub.

At 404, method 400 can include the computing system obtaining data indicative of a current location for each of the plurality of objects within the object distribution hub. For instance, the computing system can obtain data that indicates, for each of the plurality of objects to be delivered, a current physical location within the object distribution hub layout where each of the objects has been stored after receipt at the object distribution hub while awaiting delivery to a further destination.

At 406, method 400 can include the computing system determining data indicative of a respective amount of time required to transfer each of the plurality of objects from its current location within the object distribution hub to each of the plurality of loading areas. For example, the computing system can obtain data (e.g., that has been predetermined, etc.) indicative of an amount of time that it would take to transfer an object from a particular storage location to each of the loading areas associated with the object distribution hub. The computing system can determine, based on the data indicative of a current location for each of the objects, a respective amount of time that would be required to transport each of the objects to each of the loading areas associated with the object distribution hub, for example, to account for delays based on distribution hub layout in generating routes for the distribution vehicles.

For example, in some implementations, for each pair of vehicle loading area and storage location within the object distribution hub, a cost can be defined that is proportional to the distance between the vehicle loading area and the storage location (e.g., indicative of time required to move objects from the storage location to the vehicle loading area). This cost can then be used in determining what objects should be loaded on each vehicle (e.g., transferred to an associated loading area) as part of the building and/or optimization of routes in the generation of routing assignments (e.g., penalizing shipments according to their distance from the vehicle loading area, etc.). The accounting for delays based on distribution hub layout may be used in determining how delivery routes are built without influencing the way objects are stored within the distribution hub (e.g., the way objects are placed within the distribution hub when obtained).

At 408, method 400 can include the computing system determining routing assignment data for a distribution vehicle based at least in part on the delivery destinations and the respective amount of time required to transfer each of the plurality of objects to each distribution vehicle loading area. In some implementations, the routing assignment data for each distribution vehicle can identify a set of one or more objects of the plurality of objects to be delivered by the distribution vehicle, a particular loading area for the set of one or more objects to be loaded into the distribution vehicle, and a route for the distribution vehicle to travel from the object distribution hub to the delivery destinations respectively associated with the set of one or more objects.

For example, the computing system can receive as input data indicative of objects being transported including the delivery destination for each object, where the objects being transported are currently located in the object distribution hub, and what delivery vehicles and associated loading areas are available for routing of the object deliveries. The computing system can then determine routing assignment data for the delivery vehicle(s) indicative of what object(s) should be loaded onto each vehicle based in part on the current location of the objects in the distribution hub as well as the delivery destination(s), thereby taking into account operation delays associated with a distribution hub layout.

In some example implementations, the computing system can obtain geographical/maps data (e.g., from one or more remote services, etc.) that can include driving directions, driving times, distances, and/or traffic conditions (e.g., predicted and/or live) for use in the determining of the routing assignment data.

Additionally, in some example implementations, the computing system can provide for optimizing routing assignment data generation using chained solves of multiple different cost functions. As examples, the multiple different cost functions can seek to minimize a fleet size, minimize a distance travelled, minimize a total time travelled, minimize a work time for distribution vehicles, and/or other objectives. For instance, the computing system can provide for solving using multiple cost functions to nudge the optimization in different directions to determine a best solution. For example, routing assignment data can be optimized using a first cost function objective (e.g., minimizing time, etc.). Then, the routing assignment data (e.g., time optimized routing) can be re-optimized using a second cost function objective (e.g., minimizing distance traveled, etc.). The different cost functions can be applied to move the routing assignment data optimization back and forth, while tracking the best solution(s) at each step.

In some example implementations, routing assignment data optimization can include aggregating service times for routes. For example, routing assignment optimization can take into account the aggregate work being done at a site for delivery and/or pickup to allow for generating finer estimations of time to load/unload at each site in generating a routing assignment.

At 410, method 400 can include the computing system providing the routing assignment data to facilitate loading and delivery of the set of one or more objects. For example, the computing system can provide the route assignment data to enable a fleet of distribution vehicles to deliver objects from a distribution hub to respective delivery destinations. For example, the distribution vehicles can perform “last mile” delivery of the objects from the distribution hub to respective delivery destinations (e.g., homes, business, etc.).

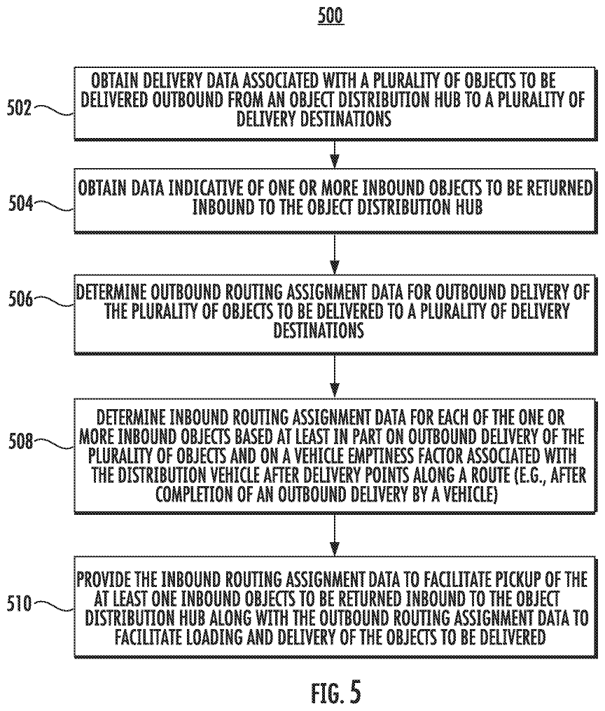

FIG. 5 depicts a flowchart diagram of example method 500 for generating mixed outbound and inbound routing assignments according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure. Method 500 can be implemented by one or more computing systems, such as one or more of the computing devices depicted in FIG. 1.

At 502, method 500 can include the computing system (e.g., computing device 102, routing assignment architecture 200, etc.) obtaining delivery data associated with a plurality of objects that are to be delivered outbound from an object distribution hub to a plurality of delivery destinations. For example, the delivery data can be associated with “last mile” delivery of the objects from the object distribution hub to respective delivery destinations (e.g., homes, business, etc.) to be performed by a fleet of vehicles associated with the object distribution hub.

At 504, method 500 can include the computing system (e.g., computing device 102, routing assignment architecture 200, etc.) obtaining data indicative of one or more inbound objects to be returned inbound to the object distribution hub. For example, one or more objects may be scheduled to be picked up and returned inbound to the object distribution hub, for example, to be then be transported from the distribution hub to a new delivery destination. As an example, in some implementations, the data may include indications of a pickup location, a time window for pickup, pickup object data (e.g., volume, weight, pallet loading constraints, etc.) and/or the like.

At 506, method 500 can include the computing system determining outbound routing assignment data for outbound delivery of the plurality of objects to be delivered to a plurality of delivery destinations. For example, the computing system can determine outbound routing assignment data for a distribution vehicle based at least in part on the delivery destinations and a respective amount of time required to transfer each of the plurality of objects to each distribution vehicle loading area associated with the hub. In some implementations, the outbound routing assignment data for each distribution vehicle can identify a set of one or more objects of the plurality of objects to be delivered by the distribution vehicle, a particular loading area for the set of one or more objects to be loaded into the distribution vehicle, and a route for the distribution vehicle to travel from the object distribution hub to the delivery destinations respectively associated with the set of one or more objects.

At 508, method 500 can include the computing system determining inbound routing assignment data for each of the one or more inbound objects based at least in part on outbound deliveries for the plurality of objects (e.g., delivery routes, delivery timing, etc.) as well as a vehicle emptiness factor associated with a distribution vehicle after delivery points along the route (e.g., after delivery of one or more of the plurality of objects at a particular destination on a route). In some implementations, the computing system may provide for routing assignments including a mix of outbound deliveries and inbound pickups in routes, for example where deliveries are executed outbound from the distribution hub first and then inbound pickups are made on a return route to the distribution hub, or where one or more inbound pickups among are interspersed among the outbound deliveries along a route. The routing assignment data for a distribution vehicle can include inbound routing assignments for at least one of the inbound objects in addition to outbound routing assignments for the set of one or more objects to be delivered from the hub. For example, the computing system can determine routing assignments where one or more inbound object pickups are scheduled among the outbound deliveries along a route for a distribution vehicle. The computing system can use a vehicle emptiness factor in determining the routing assignment data for the inbound objects. The vehicle emptiness factor can be indicative of how empty a distribution vehicle is after a respective delivery stop, thereby providing for a determination if there is space within the distribution vehicle to move objects to allow for loading inbound pickups without hampering further outbound deliveries assigned to the vehicle (e.g., such that unloading and reloading objects along the route is not required). Routing assignment data can then be determined whereby a distribution vehicle can intersperse pickups of inbound objects among the outbound deliveries.

In some implementations, the vehicle emptiness factor can be defined based on user preferences. For instance, in some implementations, an emptiness factor can be set at a lower value to ensure that a vehicle has significant empty space to accommodate inbound pickups. As one example, an emptiness factor can be set at 0 (e.g., vehicle completely empty) to ensure that all deliveries are made before pickups are initiated (e.g., pure backhaul). In some implementations, such mixed inbound/outbound routing assignments can be optimized to minimize a number of vehicles required to accommodate the outbound deliveries and inbound pickups. In some implementations, such mixed inbound/outbound routing assignments can be optimized to minimize the distance traveled to accommodate the outbound deliveries and inbound pickups. In some implementations, such mixed inbound/outbound routing assignments can be optimized to minimize the travel time needed to accommodate the outbound deliveries and inbound pickups.

At 510, method 500 can include the computing system providing the inbound routing assignment data to facilitate pickup of the at least one inbound objects to be returned inbound to the object distribution hub along with the outbound routing assignment data to facilitate loading and delivery of the objects to be delivered. For example, the computing system can provide the inbound routing assignment data to enable a distribution vehicle to perform pickup of inbound objects (e.g., to be returned to the distribution hub) while completing delivery of objects from the distribution hub to respective delivery destinations based on the outbound routing assignment data.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, the method comprising:
obtaining, by one or more computing devices, delivery data associated with a plurality of objects to be delivered from an object distribution hub to a plurality of delivery destinations, wherein a plurality of loading areas are associated with the object distribution hub;
obtaining, by the one or more computing devices, data indicative of a current location for each of the plurality of objects within the object distribution hub;
determining, by the one or more computing devices, data indicative of a respective amount of time required to transfer each of the plurality of objects from its current location within the object distribution hub to each of the plurality of loading areas;
determining, by the one or more computing devices, routing assignment data for a distribution vehicle based at least in part on the delivery destinations and the respective amount of time required to transfer each of the plurality of objects to each distribution vehicle loading area, wherein the routing assignment data for the distribution vehicle identifies:
a set of one or more objects of the plurality of objects to be delivered by the distribution vehicle;
a particular loading area for the set of one or more objects to be loaded into the distribution vehicle; and
a route for the distribution vehicle to travel from the particular loading area to the delivery destinations respectively associated with the set of one or more objects; and
providing, by the one or more computing devices, the routing assignment data to facilitate loading and delivery of the set of one or more objects.

2. The computer-implemented method of claim 1, wherein determining, by the one or more computing devices, the routing assignment data comprises optimizing, by the one or more computing devices, an objective cost function that evaluates a travel time associated with the distribution vehicle, and wherein the travel time associated with the distribution vehicle is a function of the respective amount of time required to transfer at least one of the one or more objects in the set of one or more objects from its current location within the object distribution hub to each of the plurality of loading areas.

3. The computer-implemented method of claim 1, wherein the data indicative of the respective amount of time required to transfer each of the plurality of objects from the current location within the object distribution hub to each of the plurality of loading areas comprises a cost factor proportional to a respective distance from the current location to each of the plurality of loading areas.

4. The computer-implemented method of claim 1, wherein determining, by the one or more computing devices, the routing assignment data comprises performing, by the one or more computing devices, multiple optimization routines for the routing assignment data using multiple different objective cost functions, wherein each of the multiple optimization routines comprises iteratively solving one of the multiple different objective cost functions.

5. The computer-implemented method of claim 4, wherein performing, by the one or more computing devices, multiple optimization routines for the routing assignment data using multiple different objective cost functions comprises tracking, by the one or more computing devices, a current preferred routing solution during each of the multiple optimization routines.

6. The computer-implemented method of claim 4, wherein performing, by the one or more computing devices, multiple optimization routines for the routing assignment data using multiple different objective cost function comprises generating, by the one or more computing devices, a ranked list of routing solutions.

7. The computer-implemented method of claim 1, the method further comprising:
obtaining, by the one or more computing devices, data indicative of one or more inbound objects to be returned inbound to the object distribution hub;
determining, by the one or more computing devices, inbound routing assignment data for each of the one or more inbound objects based at least in part on a vehicle emptiness factor associated with the distribution vehicle after delivery points along the route, wherein the routing assignment data for the distribution vehicle further comprises inbound routing assignments for at least one of the inbound objects in addition to outbound delivery assignments for the set of one or more objects; and
providing, by the one or more computing devices, the inbound routing assignment data to facilitate pickup of the at least one inbound object to be returned inbound to the object distribution hub.

8. The computer-implemented method of claim 7, wherein determining, by the one or more computing devices, the inbound routing assignment data comprises performing, by the one or more computing devices, an optimization of the routing assignment data based at least in part on aggregated service times for delivery of the set of one or more objects and service times for pickup of the at least one inbound objects on the route.

9. The computer-implemented method of claim 1, wherein determining the routing assignment data comprises optimizing an objective function that seeks to minimize a number of distribution vehicles employed to deliver the plurality of objects.

10. The computer-implemented method of claim 1, wherein determining the routing assignment data comprises optimizing an objective function that seeks to minimize a distance traveled to deliver the plurality of objects.

11. The computer-implemented method of claim 1, wherein determining the routing assignment data comprises optimizing an objective function that seeks to minimize a total working time for distribution vehicles employed to deliver the plurality of objects.

12. A computing system, comprising:
one or more processors; and
one or more non-transitory computer-readable media that store instructions that, when executed by the one or more processors, cause the computing system to perform operations, the operations comprising:
obtaining delivery data associated with a plurality of objects to be delivered outbound from an object distribution hub, wherein the delivery data includes a delivery destination for each of the plurality of objects and wherein a plurality of loading areas are associated with the object distribution hub;
obtaining data indicative of a current location for each of the plurality of objects within the object distribution hub;
determining data indicative of a respective amount of time required to transfer each of the plurality of objects from its current location within the object distribution hub to each of the plurality of loading areas associated with the object distribution hub;
determining routing assignment data for a distribution vehicle based on the delivery destination for each of the plurality of objects and the respective amount of time required to transfer each of the one or more objects in the set of objects to the plurality of loading areas, wherein the routing assignment data identifies a particular loading area and a set of one or more objects of the plurality of objects to be loaded onto the distribution vehicle at the particular loading area, wherein the routing assignment data further identifies a route for the distribution vehicle to travel from the particular loading area to the delivery destinations respectively associated with the set of one or more objects; and
providing the routing assignment data to facilitate loading and delivery of the set of one or more objects.

13. The computing system of claim 12, wherein determining the routing assignment data comprises optimizing an objective cost function that evaluates a travel time associated with the distribution vehicle, and wherein the travel time associated with the distribution vehicle is a function of the respective amount of time required to transfer at least one of the one or more objects in the set of objects from its current location within the object distribution hub to each of the plurality of loading areas.

14. The computing system of claim 12, wherein the data indicative of the respective amount of time required to transfer each of the plurality of objects from the current location within the object distribution hub to each of the plurality of loading areas comprises a cost factor proportional to a respective distance from the current location to each of the plurality of loading areas.

15. The computing system of claim 12, wherein determining the routing assignment data comprises performing multiple optimization routines for the routing assignment data using multiple different objective cost functions, wherein each of the multiple optimization routines comprises iteratively solving one of the multiple different objective cost functions.

16. The computing system of claim 12, the operations further comprising:
obtaining data indicative of one or more inbound objects to be returned inbound to the object distribution hub;
determining inbound routing assignment data for each of the one or more inbound objects based at least in part on a vehicle emptiness factor associated with the distribution vehicle after delivery points along the route, wherein the routing assignment data for the distribution vehicle further comprises inbound routing assignments for at least one of the inbound objects in addition to outbound delivery assignments for the set of one or more objects; and
providing the inbound routing assignment data to facilitate pickup of the at least one inbound objects on the route.

17. The computing system of claim 16, wherein determining the inbound routing assignment data comprises performing an optimization of routing assignment data based at least in part on aggregated service times for delivery of the set of one or more objects and service times for pickup of the at least one inbound objects on the route.

18. The computing system of claim 12, wherein determining the routing assignment data comprises optimizing an objective function that seeks to minimize a number of distribution vehicles employed to deliver the plurality of objects.

19. One or more non-transitory computer-readable media that store instructions that, when executed by one or more processors of a computing system, cause the computing system to:
obtain delivery data associated with a plurality of objects to be delivered from an object distribution hub, wherein the delivery data includes a delivery destination for each of the plurality of objects and wherein a plurality of loading areas associated with the object distribution hub;
obtain data indicative of a current location for each of the plurality of objects within the object distribution hub;
determine data indicative of a respective amount of time required to transfer each of the plurality of objects from its current location within the object distribution hub to each of the plurality of loading areas associated with the object distribution hub;
determine routing assignment data for a distribution vehicle associated with each of the plurality of loading areas, wherein the routing assignment data identifies a determination of a set of one or more objects of the plurality of objects to be delivered by the distribution vehicle based on the delivery destination for each of the plurality of objects and the amount of time required to transfer each of the one or more objects in the set of objects to an associated loading area, wherein the routing assignment data further identifies a route for the distribution vehicle to travel from the associated loading area to the delivery destinations respectively associated with the set of one or more objects; and
provide the routing assignment data to facilitate loading and delivery of the set of one or more objects.

20. The one or more non-transitory computer-readable media of claim 19, wherein the data indicative of the respective amount of time required to transfer each of the plurality of objects from the current location within the object distribution hub to each of the plurality of loading areas comprises a cost factor proportional to a respective distance from the current location to each of the plurality of loading areas.
